(19) United States
(12) Patent Application Publication
(10) Pub. No.: US 2026/0364762 A1
(43) Pub. Date: Nov. 19, 2026

(54) Hammer mechanism for an electric hand-held power tool machine

(71) Applicant: Hilti Aktiengesellschaft, Schaan (LI)

(72) Inventors: Maximilian KNYRIM, Ehingen (DE); Daniel SELTMANN, Türkheim (DE); Aaron WIEDNER, Landsberg (DE)

(21) Appl. No.: 19/128,027

(22) PCT Filed: Nov. 2, 2023
(86) PCT No.: PCT/EP2023/080556

§ 371 Date: May 7, 2025

(30) Foreign Application Priority Data
Nov. 15, 2022 (EP) 22207434.6

(51) Int. Cl. B25D 11/12

(52) U.S. Cl. CPC B25D 11/12; B25D 2250/331

(57) ABSTRACT

A hammer mechanism for an electric hand-held power tool machine, including a crank mechanism for converting a rotational drive movement of an electric motor via a connecting rod driven by a crank disk into a translationally alternating movement of an exciter piston for axially applying impact energy to a tool, wherein the connecting rod is provided with a bearing pin section which is integrally formed thereon at the piston end and which interacts with the exciter piston to form a pivot bearing, which exciter piston is composed at least of a piston crown part and a piston skirt part, wherein a concave bearing shell section associated with the bearing pin section of the connecting rod is integrally formed on the inside of the piston crown part, which bearing shell section, to form the pivot bearing, interacts oppositely with at least one concave bearing shell section integrally formed on the inner side of the piston skirt part.

The invention relates to a hammer mechanism for an electric hand-held power tool machine.

### BACKGROUND

The field of application of the invention extends primarily to hand-held hammer drills or chisel hammers, which are equipped with an electric motor drive. Such electric hand-held power tool machines generate a linear alternating working movement via a mechanical hammer mechanism, i.e., a reciprocating movement for striking the tool, which, in the case of a chisel hammer, is designed as a mortise chisel and, in the case of a hammer drill, is designed as a percussion drill for working on preferably mineral materials—such as stone, concrete, and the like. The exciter piston of the hammer mechanism does not act directly upon the clamped tool, but via a pneumatic coupling. For this purpose, the exciter piston acts from one end upon a cylinder chamber via the crank drive, at the opposite end of which an impact piston is arranged, which impact piston acts upon the tool in the striking direction. The tool is thus indirectly acted upon by the exciter piston in a pneumatically-damped manner. In addition, it is also conceivable to carry out a direct application of a tool or to integrate further components into the operative chain—for example, a snap die.

### SUMMARY OF THE INVENTION

WO 2015/049130 A1 discloses an electric hand-held power tool machine of the type of interest here with a pneumatic hammer mechanism. The hammer mechanism comprises a striker movable along the impact axis, an exciter piston connected by a connecting rod to the drive by crank drive, and a pneumatic cylinder chamber, which couples the movement of the striker piston to the exciter piston. The connecting rod is attached pivotably in the exciter piston, for which purpose, in an embodiment disclosed here, a separate piston pin is used. In another embodiment, a convex bearing shell section is integrally formed on the inside of a pot-shaped exciter piston on the bottom side, which convex bearing shell section, to form the pivot bearing, interacts oppositely with a concave end face of the connecting rod. Admittedly, a forward-stroke bearing of the connecting rod can be created thereby, but not a return-stroke bearing. This is realized via additional rearward retaining tabs. In this prior art, the exciter piston is formed in one piece.

In contrast, WO 2017/220561 A1 discloses a hammer mechanism of an electric hand-held power tool machine having a multi-part exciter piston that is of interest here. This is composed of a pot-shaped piston crown part and a likewise pot-shaped piston skirt part which are mounted in an interlocking manner. The connecting rod bearing at the piston end is not effected by means of a separate piston pin, but, rather, via a bearing pin section formed on the end of the connecting rod. This bearing pin section interacts at the piston end with two inserted bearing shells which surround the bearing pin section. The two bearing shells consist of a material different from that of the piston crown part and the piston skirt part of the exciter piston. All components of the exciter piston are made of a metal, which overall causes a very high moving mass that impairs the efficiency of the hammer mechanism.

It is an object of the present invention to further improve a hammer mechanism for an electric hand-held power tool machine of the generic type in such a way that the efficiency of the hammer mechanism is increased by simple technical measures.

The present invention provides a hammer mechanism (8) for an electric hand-held power tool machine, comprising a crank mechanism for converting a rotational drive movement of an electric motor (12) via a connecting rod (15) driven by a crank disk (14) into a translationally alternating movement of an exciter piston (13) for axially applying impact energy to a tool, wherein the connecting rod (15) is provided with a bearing pin section (17) integrally formed thereon at the piston end, which bearing pin section interacts with the exciter piston (13) in order to form a pivot bearing, which exciter piston is composed of at least a piston crown part (18) and a piston skirt part (19).

The invention includes the technical teaching that, in order to form a pivot bearing in the case of a multipart exciter piston, a concave bearing shell section associated with the bearing pin section of the connecting rod is integrally formed on the inside of the piston crown part, said concave bearing shell section interacting oppositely with at least one concave bearing shell section integrally formed on the inner side of the piston skirt part in order to form a plain bearing.

The formation of the respective bearing sections directly at the associated components of the exciter piston makes it possible to provide material for the bearing function only where this is required. In contrast, separate insert parts would have to be fitted into the inner contour of the piston crown part and piston skirt part in a captive and positionally correct manner, for which purpose correspondingly more material is required. The exciter piston, which is lightweight in comparison, contributes to an increase in the efficiency of the hammer mechanism. Device vibration and wear of the crank drive are also reduced by the reduced mass.

The solution according to the invention satisfies the requirement that the connecting rod together with the bearing pin and also the multi-part exciter piston together with the integrally-formed bearing shell sections be able to be produced from a plastic by casting. On the one hand, depending upon the material, the movable mass can be further reduced in comparison to a metal material; on the other hand, casting the said components opens up efficient production. The components are preferably produced by injection-molding.

In order, in particular, to further reduce the mass of the connecting rod, according to a measure improving the invention, it is proposed that the bearing journal section integrally formed on the connecting rod be provided with at least one recess introduced at the end face for mass reduction. This recess can be implemented continuously or in the manner of basic holes, depending upon the strength required. The recess makes a further contribution to saving upon material.

According to a preferred embodiment for the piston crown part, it is designed to be pot-shaped and, thanks to being preferably produced by casting, can be designed with a wall thickness of approximately the same thickness. The wall thickness is dimensioned to be minimal, as appropriate for the loading, in order to make a further contribution to mass reduction.

In the context of this embodiment, it is further proposed that the pot-shaped piston crown part of the exciter piston be provided with a U-shaped circumferential groove, in the radially outward edge region close to the bottom, for receiving an elastomer sealing ring. A conventional O-ring or the like can be used-for example, as the elastomer sealing ring. The connection point to the piston skirt part is located outside the U-shaped circumferential groove. However, it is also conceivable to place the circumferential groove on the piston skirt part or to realize the component separation in the region of the circumferential groove.

According to a further measure improving the invention, it is proposed that, in the adjacent region to the adjacent piston crown part, the piston skirt part of the exciter piston have a relief recess for further mass reduction. The actual guide surface of the exciter piston is then formed by the piston skirt part edge region that is remote from the piston crown. In the sense of a further saving upon material, this edge region can also be designed to be undulatory, so that a non-cylindrical piston guide surface results.

According to a further measure improving the invention, it is proposed that the sleeve-shaped piston skirt part have a guide section at least partially surrounding the connecting rod below the integrally-formed bearing pin section. This guide section is designed such that it does not hinder the alternating pivoting movement of the connecting rod, but forms lateral, oppositely parallel guide surfaces. The guided region of the connecting rod has a clearance fit opposite the guide section of the exciter piston.

Furthermore, it should be noted that the length of the bearing pin section of the connecting rod and the diameter of the piston should be in a geometric ratio of preferably ≥0.3, and very preferably ≥0.5. This rather high ratio results in a correspondingly lower surface pressure and thereby, advantageously, less wear of the piston bearing.

In order to reduce heat development in the region of the connecting rod bearing during operation, it is proposed according to a further optional measure that a metal sheet be arranged between the concave bearing shell section of the piston crown part and the bearing pin section of the connecting rod. It should be noted that the use of such a metal sheet is not limited to multi-part excitation pistons of the generic type. Such an additional metal sheet can be used in any type of exciter piston and makes sense in particular in the case of exciter pistons and connecting rods made of a plastic. Since such a metal sheet preferably consisting of steel with a sheet thickness between 0.2 and 2 mm—reduces sliding friction, plain bearing properties are improved, which leads to less heat development. The metal sheet bent in a half-shell shape can be placed or inserted between the said components. There should preferably be an arrangement on the piston crown part, since it is there that the highest load prevails. The half-shell-shaped metal sheet is preferably fixed in position on the piston crown part or on the connecting rod via edge sections bent radially inwards or radially outwards. A positive-locking positional fixation is sufficient for this purpose. However, an overmolding of an inserted metal sheet with plastic can also take place in order to captively connect said metal sheet to the piston crown part. In addition, it is also conceivable to arrange such a metal sheet on the bearing shell section of the piston skirt part.

In order to reduce a leakage and a jamming of the exciter piston in the associated cylinder tube in view of the multi-part design, it is proposed that the piston crown part be alternatively designed as a flat cap—i.e., in contrast to the embodiment described above, not pot-shaped—but for the bearing pin section described above to be integrally formed on the inside. This cap-shaped piston crown part covers the sleeve-shaped piston skirt part at the end and preferably has a smaller diameter than the maximum diameter of the piston skirt part in order to prevent jamming. This design achieves a displacement of the component separation in the direction of the piston crown. As a result, the sealing point of the piston seal and also the guiding piston section are located in one and the same component, viz., the piston skirt part, which in this respect handles the guiding and sealing function. The connecting rod is enclosed, held, and guided in the piston skirt part by the attached cap-shaped piston crown part. The reduced diameter of the piston crown part is preferably 90 to 99% of the diameter of the piston skirt part. The latter is, in the edge region close to the piston crown, provided with a U-shaped circumferential groove for receiving the elastomer sealing ring.

In order to further minimize the plain bearing wear of the piston bearing, according to a further measure improving the invention, it is proposed that the single bearing shell section of the piston crown part form a forward-stroke bearing of the connecting rod, and two bearing shell sections of the piston skirt part arranged on the two sides of the connecting rod flanks form a return-stroke bearing of the connecting rod. Here, all bearing shell sections can constitute cylinder-segment-shaped bearing locations with a maximally semicircular enclosure of the bearing pin section. As a result, the plain bearing location of the connecting rod in the exciter piston is divided into three bearing shells, which are preferably designed as half-shells. The separation of the plain bearing location in the forward and return stroke bearings enables a maximization of the particularly loaded forward stroke bearing for the compression. Thanks to the maximization of the bearing surfaces, the surface pressure decreases correspondingly, which leads to less wear. The one-piece design of the bearing shell sections with the respectively associated components of the exciter piston satisfies the requirement for reducing the plain bearing play compared to the prior art described at the outset, in order to achieve an optimal plain bearing.

In order to achieve a further reduction in the heat development in the region of the plain bearing of the exciter piston, according to a further measure improving the invention, it is proposed that at least one lubrication groove be introduced into the running surface of the bearing shell section of the piston crown part as the bearing zone that is most loaded. This lubrication groove can be filled with a suitable lubricant as a permanent lubrication point or can also be connected to a lubricant circuit of a pressure lubrication. As a result, the component surfaces of the connecting rod bearing that slide over each other are provided with a lubricating film. Here, a single lubrication groove is sufficient, which is preferably arranged centrally in the longitudinal direction of the bearing shell section and runs in the transverse direction along the curved shape of the bearing shell section. However, it is also conceivable to integrate more than one lubrication groove into the bearing shell sections in a functionally appropriate manner. A symmetrical arrangement below the connecting rod shaft ensures a uniform supply of lubricant to the plain bearing surfaces. The at least one lubrication groove is preferably designed such that a volume is available for 0.02 to 2 cm³ of lubricant. This at least one lubrication groove can be provided independently of the above-mentioned metal sheet, i.e., instead or additionally, and is also not bound to a multi-part exciter piston.

The component connection between the piston crown part and the piston skirt part can preferably be effected by welding or adhesive bonding, whereby expelled weld material or excess adhesive arises. In order that this not impair a functionally accurate component positioning, according to a further measure improving the invention, it is proposed that at least one recess for receiving weld or adhesive residues be arranged adjacent to the at least one welding or bonding point on the piston crown part and/or on the piston skirt part.

If the welding or bonding point takes the form of a weld seam, it is recommended that there be arranged on both sides thereof a groove-shaped recess for receiving the residues. The recess should provide sufficient volume to hold all the expelled weld material or the excess adhesive. The volume can be in the range of 0.1 times to 10 times a weld seam volume in order to reach this target. Preferably, the cross-section of the groove-shaped recess for receiving welding residues should be larger than the cross-section of the thickest weld seam. To maximize the receiving capacity, the cross-section of the groove-shaped recess can also be shell-shaped.

In order to achieve a positionally correct installation of an exciter piston composed of the piston crown part and the piston skirt part, according to a further measure improving the invention, it is proposed that at least one centering lug which extends towards the opposite connection partner and engages in a corresponding recess be integrally formed on the piston crown part and/or on the piston skirt part. This allows the components to be positioned rotationally accurately during assembly. The centering lugs position the two components in the correct rotational position relative to one another before the exciter piston is finally joined.

The distal end sections of the centering lug preferably have at least one lead-in bevel for easier assembly. The lead-in bevel has a lead-in angle in the preferred range of 5 to 50 degrees. Furthermore, the centering lug can also be provided with a recess in order to achieve further mass reduction in this region. This is because the flank sides of the centering lug are sufficient for the intended function.

### BRIEF DESCRIPTION OF THE DRAWINGS

Further measures improving the invention are explained in more detail below together with the description of preferred exemplary embodiments of the invention with reference to the figures. In the drawings:

FIG. 1 shows a schematic side view of an electric hand-held power tool machine designed as a chisel hammer with an integrated pneumatic hammer mechanism,

FIG. 2 shows a longitudinal section through the exciter piston/connecting rod assembly,

FIG. 3 shows a further longitudinal section through the exciter piston/connecting rod assembly,

FIG. 4 shows a longitudinal section through the piston region,

FIG. 5 shows a longitudinal section through the piston region with a sheet metal insert in a first embodiment,

FIG. 6 shows a longitudinal section through the piston region with a sheet metal insert in a second embodiment,

FIG. 7 shows a longitudinal section through the piston region with an alternative piston crown part,

FIG. 8 shows a perspectival view of an exciter piston in section,

FIG. 9a shows a detailed section in the region of the component connection in a first embodiment,

FIG. 9b shows a detailed section in the region of the component connection in a second embodiment,

FIG. 10 shows a longitudinal section through the exciter piston, and

FIG. 11 shows a detail view of a piston crown part with recess.

### DETAILED DESCRIPTION

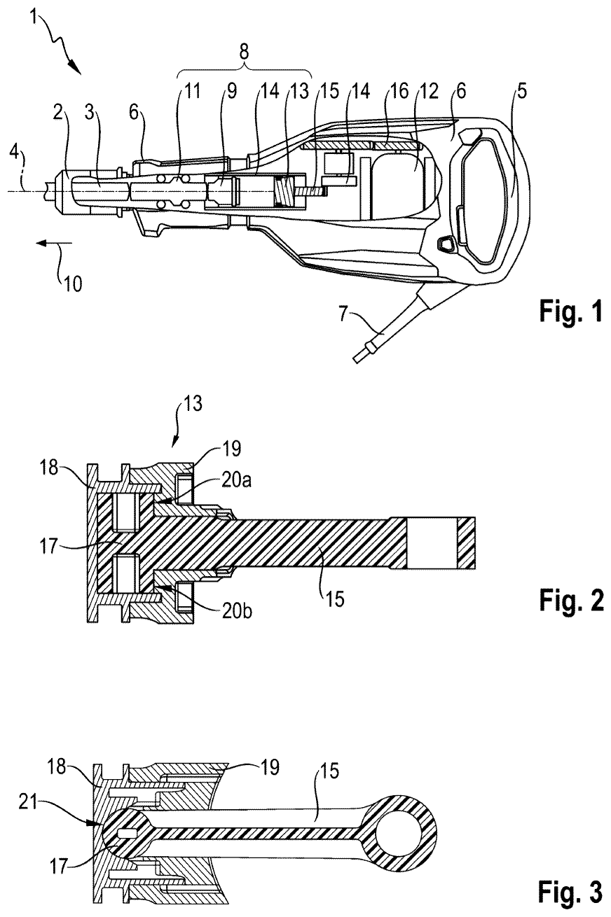

FIG. 1 shows an electric hand-held power tool machine in the form of a chisel hammer 1. The chisel hammer 1 has a front tool holder 2, in which a chisel 3 can be inserted along a working axis 4 and locked. At the rear end, the electric hammer 1 has a handle 5 which is integrally formed on a machine housing 6. An additional handle can be fastened to the machine housing 6 near the tool holder 2. For power supply, an electrical mains power 7 proceeds from machine housing 6.

The chisel hammer 1 has an integrated pneumatic hammer mechanism 8 with an impact piston 9 which, during operation, periodically applies impacts to the chisel 3 along the working axis 4 in the striking direction 10. The impact piston 9 is movably guided along the working axis 4 and, in the embodiment shown, strikes the chisel 3 indirectly via a snap die 11. The snap die 11 is in this respect arranged in the striking direction 10 between the impact piston 9 and the tool holder 2.

The pneumatic hammer mechanism 8 is driven by an electric motor 12 and moves an exciter piston 13 in translatory alternation on the working axis 4 by means of a crank drive. The impact piston 9 opposite is coupled to the exciter piston 13 via an air spring.

The hammer mechanism 8 comprises a cylindrical guide tube 14 for pneumatic coupling, in which guide tube the exciter piston 13 is guided along the working axis 4 in a dynamically-sealed manner. The exciter piston 13 thus closes the guide tube 14 in an airtight manner counter to the striking direction 10.

A connecting rod 15 driven by a crank disk 114 forms part of the crank mechanism for the exciter piston 13. The crank disk 114 is driven by the electric motor 12 via a spur gear stage 16.

According to FIG. 2, the connecting rod 15, which is made of plastic, is provided with a bearing pin section 17 integrally formed thereon at the piston end. To form a pivot bearing, the bearing pin section 17 interacts with an exciter piston 13 consisting of the piston crown part 18 and the piston skirt part 19. Two concave bearing shell sections 20a and 20b arranged on both sides of the connecting rod 15 are integrally formed on the inside of the piston skirt part 19.

As can be seen better from FIG. 3, a concave bearing shell section 21 is also integrally formed on the inside of the piston crown part 18. All bearing shell sections 20a, 20b, and 21 comprise the bearing pin section 17 of the connecting rod 15 for forming a piston-side pivot bearing of the crank drive, which is designed as a plain bearing.

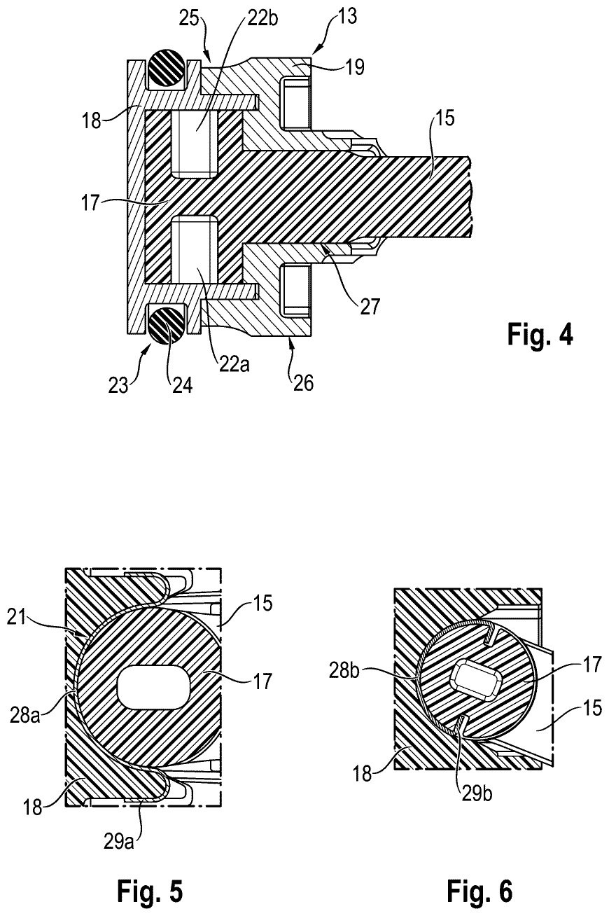

According to FIG. 4, the bearing pin section 17 of the connecting rod 15 additionally has two recesses 22a and 22b introduced therein on the end face for additional mass reduction and saving upon material.

In this exemplary embodiment, the piston crown part 18 of the exciter piston 13 is of pot-shaped design and has a wall thickness of approximately equal thickness. For dynamic sealing against the guide tube (see 14 in FIG. 1), a U-shaped circumferential groove 23 for receiving an elastomer sealing ring 24 is provided in the radially outward edge region, close to the bottom, of the piston crown part 18. Furthermore, the piston skirt part 19 has a circumferential relief recess 25 arranged next to the adjacent piston crown part 18 for further mass reduction. In this respect, piston guidance is effected via a piston guide surface 26, adjacent to the relief recess 25, of the piston skirt part 19.

The sleeve-shaped piston skirt part 19 of the hammer piston 13 is furthermore provided on the inside with a guide section 27 surrounding the connecting rod 15 in the region close to the bearing pin, which guide section guides the connecting rod 15 along the alternating pivot movement via a clearance fit on both sides.

With regard to FIG. 5, a metal sheet 28a, which is bent in the shape of a half-shell and is made of steel, is arranged between the concave bearing shell section 21 of the piston crown part 18 and the bearing pin section 17 of the connecting rod 15, which metal sheet serves to reduce heat and wear. The metal sheet 28a is fixed in position on the piston crown part 18 by means of radially outward-bent edge sections 29a and prevents a plastic-to-plastic material contact, which causes heat and friction heat in the case of the highly-loaded forward stroke bearing.

In the alternative embodiment illustrated in FIG. 6, a metal sheet 28b bent in the shape of a half-shell is fastened to the bearing pin section 17 of the connecting rod 15. For this purpose, radially inward-bent edge sections 29b are used which, as shown, engage in corresponding recesses in the connecting rod 15.

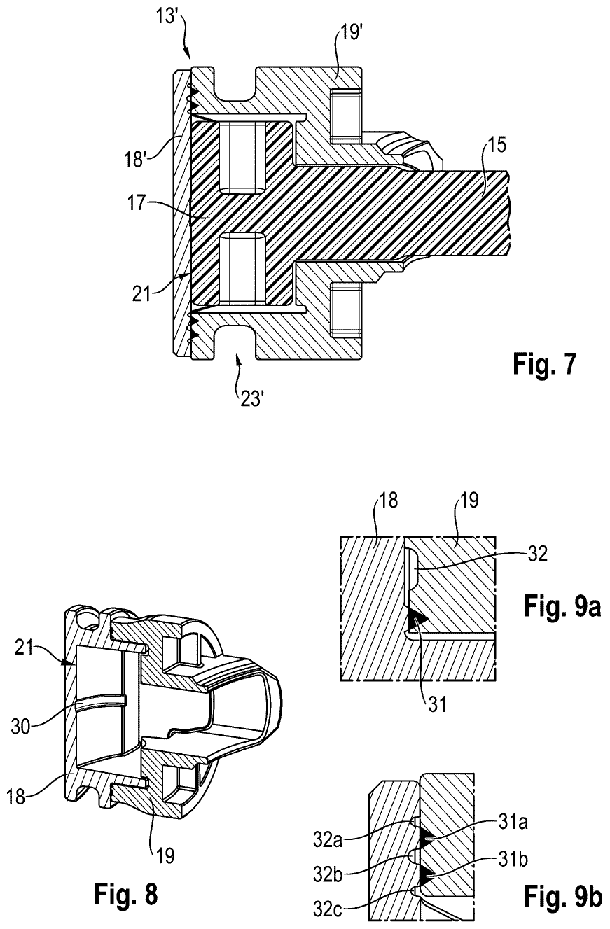

The embodiment shown in FIG. 7 shows a flat cap-shaped piston crown part 18′ with a concave bearing shell section 21 formed on the inside, as is also present in the embodiment described above. This cap-like piston crown part 18′ covers the sleeve-shaped piston skirt part 19′ at the end face and has a smaller diameter than the maximum diameter of the piston skirt part 19′ in order to prevent jamming relative to the guide tube. For dynamic sealing, in this embodiment of an exciter piston 13′, on the piston skirt part 19′, a U-shaped circumferential groove 23′ is provided for receiving an elastomer sealing ring (see, e.g., 24 in FIG. 4). Here, the circumferential groove 23′ is located in the edge region, close to the piston crown part, of the piston skirt part 19′.

As can be seen from FIG. 8, a lubrication groove 30 is introduced into the running surface of the bearing shell section 21 of the piston crown part 18. The lubrication groove 30 is arranged centrally in the longitudinal direction of the bearing shell section 21 and is introduced in the transverse direction along the curved shape of the bearing shell section 21. The lubrication groove 30 is filled with a lubricant for permanent lubrication of the plain bearing. According to FIG. 9A, the piston crown part 18, only part of which is shown here, is integrally connected to the piston skirt part 19 via a welding point 31. This welding point 31 here takes the form of a weld seam. Adjacent thereto, a groove-like recess 32 extends for receiving welding residues.

In the embodiment according to FIG. 9B, two mutually-adjacent weld seams 31a and 31b are provided for fastening the component, which are combined with groove-shaped recesses 32a to 32c arranged on both sides. The central groove-shaped recess 32b has a larger groove cross-section than the two edge-side groove-shaped recesses 32a and 32c, since first welding residues of both welding points 31a and 31b taking the form of weld seams have to be accommodated.

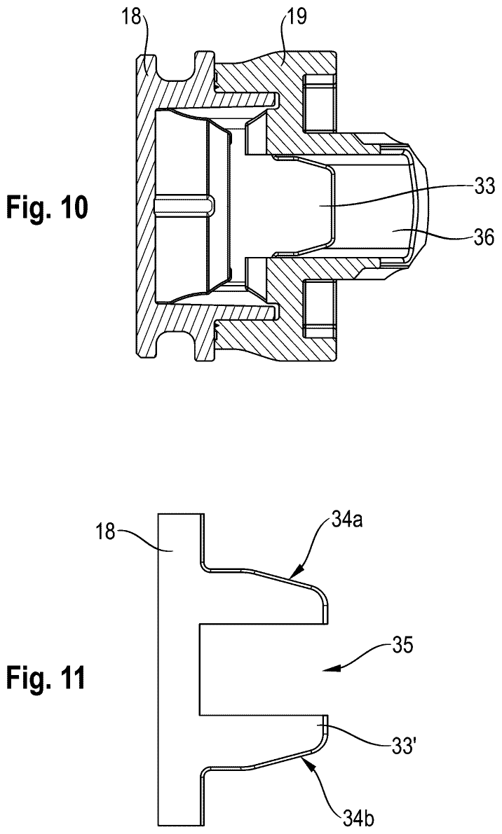

FIG. 10 furthermore shows that centering lugs 33 which extend away from the piston base are provided here on the piston crown part 18. In this exemplary embodiment, the piston crown part 18 has two centering lugs 33 opposite one another, of which only one is visible due to the illustration. Each centering lug 33 comes into engagement with a corresponding recess 36 in the piston skirt part 19 in order to ensure correct component positioning. According to FIG. 11, lead-in bevels 34a and 34-5? on the distal end section of the centering lug 33 facilitate assembly. Furthermore, the centering lug 33′ of this embodiment has a recess 35 for further saving upon mass.

The invention is not limited to the exemplary embodiments described above and their sub-variants. It is rather the case that modifications and other combinations thereof are also conceivable, which either fall within the scope of protection of the following claims or are also disclosed independently thereof.

It is thus also possible, for example, to arrange at least one lubrication groove in the region of an internal concave bearing shell section for supplying lubricant to the piston-side plain bearing location of the crank drive, regardless of the shape of the exciter piston, and, in particular, of whether this is designed in one or more parts. Such an object, generalized with respect to the following claims, can be described as follows:

Hammer mechanism for an electric hand-held power tool machine, comprising a crank mechanism for converting a rotational drive movement of an electric motor via a connecting rod driven by a crank disk or the like into a translationally alternating movement of an exciter piston for axially applying impact energy to a tool, wherein the connecting rod is provided with a bearing pin section integrally formed thereon at the piston end, which bearing pin section interacts with the exciter piston to form a pivot bearing, wherein at least one concave bearing shell section is arranged on the inside of the exciter piston, at least one lubrication groove being introduced in the running surface of said bearing pin section.

In a preferred embodiment, a single lubrication groove is arranged centrally in the longitudinal direction of the bearing shell section and is positioned running in the transverse direction along the curved shape of the bearing shell section. It is also conceivable to provide several lubricant grooves, as described above in connection with the special exciter piston.

The same also applies analogously with regard to the wear-reducing metal sheet inserts between the piston-side bearing shell section and the bearing-pin-side connecting rod. Such a metal sheet, which is preferably bent in the form of a shell, can furthermore be fixed in position by means of curved edge sections on the exciter piston or on the connecting rod, which are bent radially inwards or radially outwards.

What is claimed is:

1-19. (canceled)

20: A hammer mechanism for an electric hand-held power tool machine, the hammer mechanism comprising:
a crank mechanism for converting a rotational drive movement of an electric motor via a connecting rod driven by a crank disk into a translationally alternating movement of an exciter piston for axially applying impact energy to a tool, the connecting rod having a bearing pin section integrally formed thereon at a piston end, the bearing pin section interacting with the exciter piston to form a pivot bearing, the exciter piston including at least a piston crown part and a piston skirt part;
a concave bearing shell section, associated with the bearing pin section of the connecting rod, being integrally formed on an inside of the piston crown part, the concave bearing shell section, to form the pivot bearing, interacting oppositely with at least one curved bearing shell section integrally formed on an inside of the piston skirt part.

21: The hammer mechanism as recited in claim 20 wherein the connecting rod together with the bearing pin section or the exciter piston with the integrally formed concave and curved bearing shell sections are produced from a plastic by casting.

22: The hammer mechanism as recited in claim 20 wherein the bearing pin section integrally formed on the connecting rod is provided with at least one recess introduced into an end face for mass reduction.

23: The hammer mechanism as recited in claim 20 wherein the piston crown part is pot-shaped and has a wall thickness of equal thickness.

24: The hammer mechanism as recited in claim 23 wherein the pot-shaped piston crown part is provided with a U-shaped circumferential groove in a radially outward edge region for receiving an elastomer sealing ring.

25: The hammer mechanism as recited in claim 20 wherein a non-cylindrical piston guide surface of the exciter piston is formed by the sleeve-shaped piston skirt part and has a relief recess for mass reduction next to the piston crown part.

26: The hammer mechanism as recited in claim 20 wherein the piston skirt part has a guide section at least partially surrounding the connecting rod below the integrally-formed bearing pin section.

27: The hammer mechanism as recited in claim 20 further comprising at least one metal sheet for reducing heat or wear is arranged between the concave bearing shell section of the piston crown part and the bearing pin section of the connecting rod.

28: The hammer mechanism as recited in claim 27 wherein the metal sheet is bent in the form of a half-shell and is fixed in position on the piston crown part or on the connecting rod via edge sections bent radially inwards or radially outwards.

29: The hammer mechanism as recited in claim 20 wherein the piston crown part is designed as a flat cap with the concave bearing shell section integrally formed on the inside and covers the sleeve-shaped piston skirt part at an end face and has a smaller diameter than a maximum diameter of the piston skirt part.

30: The hammer mechanism as recited in claim 29 wherein the piston skirt part is provided with a U-shaped circumferential groove for receiving an elastomer sealing ring.

31: The hammer mechanism as recited in claim 20 wherein the concave bearing shell section of the piston crown part forms a forward stroke bearing for the connecting rod, and two of the at least one curved bearing shell section are arranged on both sides of the connecting rod to form a return stroke bearing for the connecting rod.

32: The hammer mechanism as recited in claim 31 wherein the curved and concave bearing shell sections form cylinder-segment-shaped bearing locations with a maximally semicircular enclosure of the bearing pin section.

33: The hammer mechanism as recited in claim 20 wherein at least one lubrication groove is in a running surface of the concave bearing shell section of the piston crown part.

34: The hammer mechanism as recited in claim 33 wherein the at least one lubrication grooves is one single lubrication groove arranged centrally in a longitudinal direction of the concave bearing shell section and runs in a transverse direction along the curved shape of the concave bearing shell section.

35: The hammer mechanism as recited in claim 20 wherein the piston crown part and the piston skirt part are connected to one another by welding or gluing, and wherein at least one recess for receiving welding or adhesive residues is arranged adjacent to the at least one welding or bonding point on the piston crown part or on the piston skirt part.

36: The hammer mechanism as recited in claim 35 wherein the at least welding or bonding point is designed as a weld seam, a groove-shaped recess for receiving welding residues being assigned on both sides to the weld seam.

37: The hammer mechanism as recited in claim 20 wherein at least one centering lug extends towards an opposite connection partner and engaging in a corresponding recess is integrally formed on the piston crown part or on the piston skirt part.

38: The hammer mechanism as recited in claim 37 wherein a distal end section of the at least one centering lug is provided with at least one lead-in bevel.
